(19) United States
(12) Patent Application Publication
(10) Pub. No.: US 2011/0073043 A1
(43) Pub. Date: Mar. 31, 2011

(54) Bird Feeder

(75) Inventor: David Dault, Grand Rapids, MI (US)

(73) Assignee: David Peter Dault, Grand Rapids, MI (US)

(21) Appl. No.: 12/568,248

(22) Filed: Sep. 28, 2009

(51) Int. Cl. A01K 39/04; A01K 39/01

(52) U.S. Cl. 119/57.9; 119/72; 119/57.8

(57) ABSTRACT

The present invention may include a bird feeder for feeding a bird which may include a base member including a container for nectar, a cover member to cover the base member including an opening adapted to allow the bird feed the nectar, a support member to support the base member, a pole member to connect to the support member. The cover member may include an upward extending facet member, and the upward extending facet member may include a inward inclined wall and a central aperture to allow the bird to access the nectar. The cover member may include a central aperture to cooperate with the support member, and the cover member may include a perch member to allow the bird to perch on the cover member. The base member may include a first ant moat, and the base member may include a divider member to divide the container of the base member. The base member may include a central aperture to cooperate with the support member.

### FIELD OF THE INVENTION

The present invention relates to bird feeders and more particularly to a hummingbird feeder.

### BACKGROUND

Conventional hummingbird feeder typically includes a small-mouth bottle and a base. Due to presence of high sugar content in hummingbird nectar, which results in accumulation of solids and growth of mold inside the bottle and base, cleaning of the feeder must be frequent to maintain a desirable level of performance. Such frequent cleaning is considered by many users to be difficult for several reasons. For example, the users must use a variety of brushes that can fit into the small mouth of the bottle to clean the interior. Cleaning using a rag or sponge is generally impractical.

### SUMMARY

The present invention may include a bird feeder for feeding a bird which may include a base member including a container for nectar, a cover member to cover the base member including an opening adapted to allow the bird feed the nectar, a support member to support the base member, a pole member to connect to the support member

The cover member may include an upward extending facet member, and the upward extending facet member may include an inward inclined wall and a central aperture to allow the bird to access the nectar.

The cover member may include a central aperture to cooperate with the support member, and the cover member may include a perch member to allow the bird to perch on the cover member.

The base member may include a first ant moat, and the base member may include a divider member to divide the container of the base member.

The base member may include a central aperture to cooperate with the support member.

The divider member may divide water and sugar, and the divider member may include a connecting member to connect the divider member to the base member.

The bird feeder may include a protective member that cooperates with the support member to provide a cover for the bird feeder, and the protective member may include an ant moat.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates an isometric view of the cover member of the hummingbird feeder of the present invention.

FIG. 2 illustrates a front view of the cover member of the hummingbird feeder of the present invention.

FIG. 3 illustrates a bottom view of the cover member of the hummingbird feeder of the present invention.

FIG. 4 illustrates a side view of the cover member of the hummingbird feeder of the present invention.

FIG. 5 illustrates a rearview of the cover member of the hummingbird feeder of the present invention

FIG. 6 illustrates a sectional view of the cover member of the hummingbird feeder of the present invention;

FIG. 7 illustrates an isometric view of the base member of the bird feeder of the present invention;

FIG. 8 illustrates a front view of the base member of the bird feeder of the present invention;

FIG. 9 illustrates a bottom view of the base member of the bird feeder of the present invention;

FIG. 10 illustrates a side view of the base member of the bird feeder of the present invention;

FIG. 11 illustrates a bottom view of the base member of the bird feeder of the present invention;

FIG. 12 illustrates a sectional view of the base member of the bird feeder of the present invention;

FIG. 13 illustrates a top view of a divider member to be used with the base member of the present invention;

FIG. 14 illustrates a front view of the divider member of the present invention;

FIG. 15 illustrates a bottom view of the divider member of the present invention;

FIG. 16 illustrates a isometric view of the divider member of the present invention;

FIG. 17 illustrates a side view of the divider member of the present invention;

FIG. 18 illustrates an iso-metric view of the support member of the present invention;

FIG. 19 illustrates a front view of the support member of the present invention;

FIG. 20 illustrates a bottom view of the support member of the present invention;

FIG. 21 illustrates a bottom view of the support member of the present invention;

FIG. 22 illustrates a side view of the support member of the present invention;

FIG. 23 illustrates a sectional view of the support member of the present invention;

FIG. 24 illustrates a isometric view of the bearing member of the present invention;

FIG. 25 illustrates a front view of the bearing member of the present invention;

FIG. 26 illustrates a bottom view of the bearing member of the present invention;

FIG. 27 illustrates a sectional view of the bearing member of the present invention;

FIG. 28 illustrates a side view of the bearing member of the present invention;

FIG. 29 illustrates a rearview of the bearing member of the present invention;

FIG. 30 illustrates a isometric view of the hangar member of the present invention;

FIG. 31 illustrates a side view of the hangar member of the present invention;

FIG. 32 illustrates a sectional view of the hangar member of the present invention;

FIG. 33 illustrates a top view of the hangar member of the present invention;

FIG. 34 illustrates a side view of the hangar member of the present invention;

FIG. 35 illustrates a bottom view of the hangar member of the present invention;

FIG. 36 illustrates a isometric view of the hangar fastening device of the present invention;

FIG. 37 illustrates a top view of the hangar fastening device of the present invention;

FIG. 38 illustrates a side view of the hangar fastening device of the present invention;

FIG. 39 illustrates a bottom view of the hangar fastening device of the present invention;

FIG. 40 illustrates a side view of the hangar fastening device of the present invention;

FIG. 41 illustrates a sectional view of the hangar fastening device of the present invention;

FIG. 42 illustrates an isometric view of the perch member of the present invention;

FIG. 43 illustrates a side view of the perch member of the present invention;

FIG. 44 illustrates a second side view of the perch member of the present invention;

FIG. 45 illustrates a top view of the perch member of the present invention;

FIG. 46 illustrates an isometric view of the protective member of the present invention;

FIG. 47 illustrates a top view of the protective member of the present invention;

FIG. 48 illustrates a sectional view of the protective member of the present invention;

FIG. 49 illustrates a side view of the protective member of the present invention;

FIG. 50 illustrates a bottom view of the protective member of the present invention;

FIG. 51 illustrates a side view of the protective member of the present invention:

FIG. 52 illustrates the support member 180, the base member 151 and the tray member 5201 and 5203.

FIG. 53 illustrates a perspective view of the tray member 5201.

FIG. 54 illustrates a rearview of the tray member 5201.

FIG. 55 illustrates a front view of the tray member 5201.

FIG. 56 illustrates a bottom view of the tray member 5201.

FIG. 57 illustrates a sectional view of the tray member 5201.

FIG. 58 illustrates a side view of the tray member 5201.

FIG. 59 illustrates the base member, the support member and the tray member and tray cover member 5203

FIG. 60 illustrates a perspective view for a cover for the tray member 5201;

FIG. 61 illustrates a rearview for the cover;

FIG. 62 illustrates a side for the cover;

FIG. 63 illustrates a front view for the cover;

FIG. 64 illustrates a sectional view for the cover;

FIG. 65 illustrates a bottom view for the cover;

FIG. 66a illustrates the cover member, the hanger member, the protective member, the hanger fastener device and the support member;

FIG. 66b illustrates the cover member, the hanger member, the protective member and the support member

FIG. 67 illustrates a first and second cover member, the hangar member and the protective member;

FIG. 68 illustrates a first and second cover member, the hangar member and the protective member;

FIG. 69 illustrates the base member and the support member;

FIG. 70 illustrates the base member and the support member;

FIG. 71 illustrates the base member connected to the hangar fastening device and the support member;

FIG. 72 illustrates the base member connected to the hangar fastening device and the support member;

FIG. 73 illustrates the first and second cover member the support member and the hangar member.

FIG. 74 illustrates the first and second cover member, the support member;

FIG. 75 illustrates the first and second cover member, the first and second support member;

FIG. 76 illustrates the first and second cover member, the support member.

FIG. 77 illustrates the base member and support member

FIG. 78 illustrates the base member, support member and bearing member.

### DETAILED DESCRIPTION

The present invention provides a flexible finger to allow many feeder locations or multiple feeders on a single hangar, and a fastening device may be used to support an ant moat and provide additional support under the feeder bowl under high wind conditions. The present invention includes a divider for measuring and storing sugar and water in order to make nectar and to provide effective mixing of sugar in order. The divider includes apertures in order to maintain proper water level. The divider may separate the container to hold jelly, bird food, birdseed, water, nectar etc. Separate containers with or without lids can be put in place of dividers to hold jelly, bird food, birdseed, water, nectar etc. The present invention may be used to feed humming birds or other types of birds. The lid of the present invention includes a channel defined by and inside and outside lips which help prevent leaking. The present invention provides additional perches for allowing resting places for birds. The present invention provides feeding ports which are raised hexagonal or diamond shape which may deny insects from entering the nectar and the raised ports also prevents rain from running into the feeder. The present invention has feeding ports which are raised hexagonal or diamond shape to reflect and refract light to attract birds. The present invention is formed from rigid material such as polycarbonate material. The present invention has a built in ant-moat in which the inside level is lower than outside level allowing excessive rain water to drain through inside holes. The present invention incorporates a way to attach to a pole without using threads or screws. The present invention incorporates a large ant-moat that cooperates with the pole and or the protective cover. The present invention allows users to have one or more feeders either in a hanging position or on a pole

The present invention includes a large ant moat-pole mount that cooperates with hanger above the feeder that way ants coming from where it is hung cannot climb down hanger and access feeder

The present invention includes a large ant moat-pole mount which may serve as a pole mount pole support that way ants coming from ground cannot climb up pole and access feeder

The present invention includes large ant moat-pole mount which serves as a pole mount pole support which may require no threading or screws to attach to a pole.

The present invention includes hanger w/ grooves which cooperates with base/bowl to allow more than one feeder to be hung or more than 1 feeder to be placed on a pole at a time (allows person to attach and detach feeder in seconds)

The present invention includes a double lip on cover which helps prevent leakage and includes facets to allow light reflection/refraction to attract birds.

The present invention includes individual perches which can be hung on feeder for additional resting spots.

The present invention provides a system to hang several feeders at once either on a pole or hanging from above.

The present invention provides for the capability of attaching feeder to a pole using the support member which also servers as ant moat.

The present invention provides a feeder that incorporates hanger, ant moat, and weather shield at once.

The present invention provides the following
flexible tab allows for many feeder locations on hanger;
hanger system and or tab allows more than 1 feeder to hang at a time;
hanger clip used to support larger ant moat and also extra support under the feeder bowl for occasions such as high winds etc;
divider system for measuring sugar and water to make nectar wherein the dividers have holes which allow effective mixing of sugar and water. Dividers have water lines on them for proper water level
built in ant moat-inside level lower than outside level allows rain water (excessive water to drain through inside hole which is developed by mold shutoff. (tooling conditions)
divider area in bowl not limited to dividers with holes—may be used to put separate containers to hold jelly, bird food, bird seed, water, nectar etc. (in this case the lid would not be used)
feeder is not limited to just hummingbirds
inside and outside lip of lid helps contain liquids for less leakage
additional perches can be hung on lid for additional resting places for birds
has built in perch on lid
pole washer/bearing is to be put on top of 1 inch pole so hanger can not “slip down into center of pole”
large pole-mount ant moat (insect cup) may be used for 1) pole mount 2) large hanger ant moat with clip and may accept the feeder rain guard/shield/protective member The rain guard now functions as ant-moat rain guard/shield/protective member.
pole mount-ant moat may also be put on pole with rain guard
feeding ports are raised hexagonal or diamond shape which (1) denies insects of nectar (2) raised ports also prevents rain from running into bowl
pole-mount ant moat slips into mating area of feeder bowl and slips over pole and does not require any threading or screws to attach to pole or feeder.

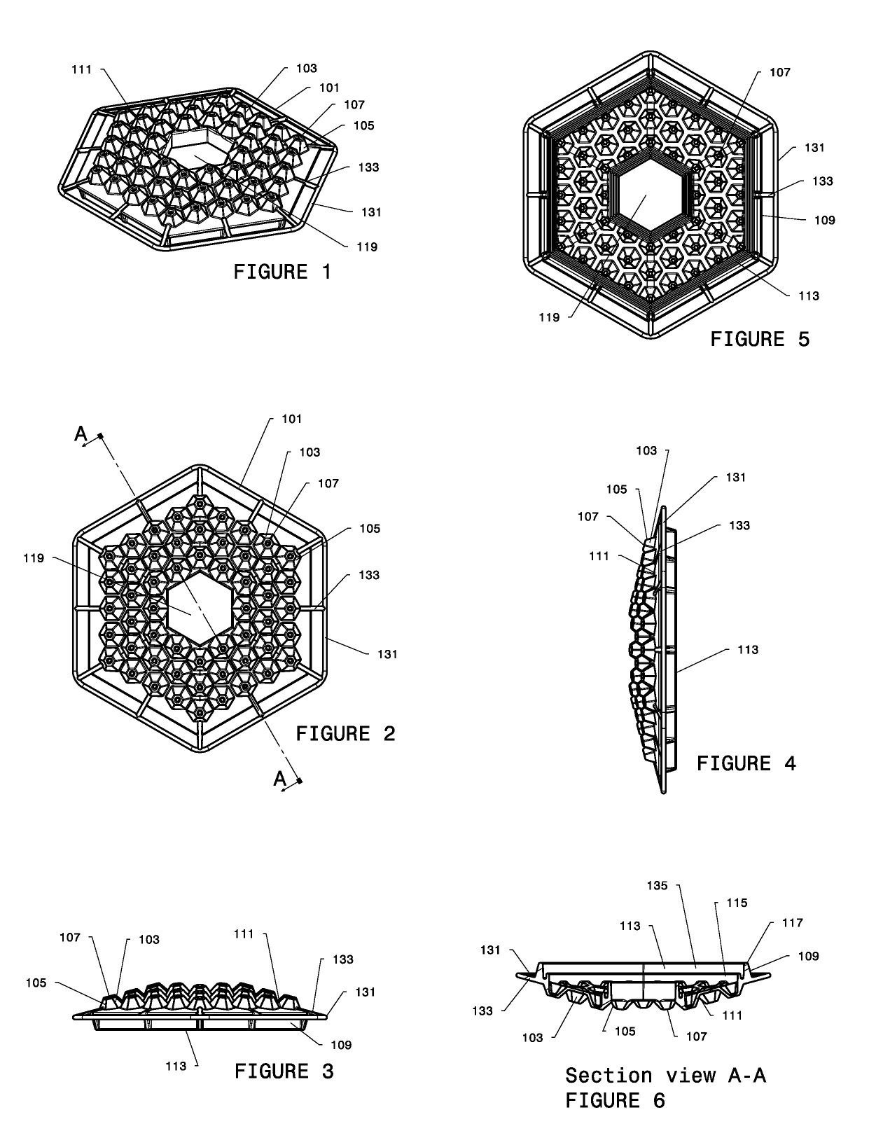

FIG. 1 illustrates an isometric view of the cover member 101 of the hummingbird feeder 100 of the present invention. FIG. 1 illustrates that the cover member 101 may include a top surface 111 which may include upward extending facet members 103 to collect light such as sunlight and reflect and refract the light in order to attract hummingbirds or other types of birds to the feeder 100. The upward extending facet members 103 may include inward inclined walls 105 which may be 4, 6, 8 in number and may include a central aperture 107 to allow the bird access to the nectar or birdseed. FIG. 1 additionally illustrates a central aperture 119 which may be six sided or other number of sided in order to be connected to the central pole. The cover member 101 may also include a perch member 131 which extends around the periphery of the cover member 101 to provide a rod or rail for the birds to rest and is positioned at a spaced relationship with the side surface 109 by a support member 133 which may be an arm to support the perch member 131.

FIG. 2 illustrates a top view of the cover member 101 of the hummingbird feeder 100 of the present invention. FIG. 2 illustrates that the cover member 101 may include a top surface 111 which may include upward extending facet members 103 to collect light such as sunlight and reflect and refract the light in order to attract hummingbirds or other types of birds to the feeder 100. The upward extending facet members 103 may include inward inclined walls 105 and may include a central aperture 107 to allow the bird access to the nectar or birdseed. FIG. 2 additionally illustrates a pole aperture 119 which may be six sided or other number of sided in order to be connected to the central pole. The cover member 101 may also include a perch member 131 which extends around the periphery of the cover member 101 to provide a rod or rail for the birds to rest and is positioned at a spaced relationship with the side surface 109 by a support member 133 which may be an arm to support the perch member 131.

FIG. 3 illustrates a side view of the cover member 101 of the hummingbird feeder 100 of the present invention. FIG. 3 illustrates that the cover member 101 may include a top surface 111 which may include upward extending facet members 103 to collect light such as sunlight and reflect and refract the light in order to attract hummingbirds or other types of birds to the feeder 100. The upward extending facet members 103 may include inward inclined walls 105 and may include a central aperture 107 to allow the bird access to the nectar or birdseed. FIG. 3 additionally illustrates a pole aperture 119 which may be six sided or other number of sided in order to be connected to the central pole. The cover member 101 may also include a perch member 131 which extends around the periphery of the cover member 101 to provide a rod or rail for the birds to rest and is positioned at a spaced relationship with the side surface 109 by a support member 133 which may be an arm to support the perch member 131.

FIG. 4 illustrates a side view of the cover member 101 of the hummingbird feeder 100 of the present invention. FIG. 4 illustrates that the cover member 101 may include a top surface 111 which may include upward extending facet members 103 to collect light such as sunlight and reflect and refract the light in order to attract hummingbirds or other types of birds to the feeder 100. The upward extending facet members 103 may include inward inclined walls 105 and may include a central aperture 107 to allow the bird access to the nectar or birdseed. FIG. 4 additionally illustrates a pole aperture 119 which may be six sided or other number of sided in order to be connected to the central pole. The cover member 101 may also include a perch member 131 which extends around the periphery of the cover member 101 to provide a rod or rail for the birds to rest and is positioned at a spaced relationship with the side surface 109 by a support member 133 which may be an arm to support the perch member 131.

FIG. 5 illustrates a bottom view of the cover member 101 of the hummingbird feeder 100 of the present invention. FIG. 5 illustrates that the cover member 101 may include a top surface 111 which may include upward extending facet members 103 to collect light such as sunlight and reflect and refract the light in order to attract hummingbirds or other types of birds to the feeder 100. The upward extending facet members 103 may include inward inclined walls 105 and may include a central aperture 107 to allow the bird access to the nectar or birdseed. FIG. 5 additionally illustrates a pole aperture 119 which may be six sided or other number of sided in order to be connected to the central pole. The cover member 101 may also include a perch member 131 which extends around the periphery of the cover member 101 to provide a rod or rail for the birds to rest and is positioned at a spaced relationship with the side surface 109 by a support member 133 which may be an arm to support the perch member 131.

FIG. 6 illustrates a sectional view of the cover member 101 of the hummingbird feeder 100 of the present invention. FIG. 6 illustrates that the cover member 101 may include a top surface 111 which may include upward extending facet members 103 to collect light such as sunlight and reflect and refract the light in order to attract hummingbirds or other types of birds to the feeder 100. The upward extending facet members 103 may include inward inclined walls 105 and may include a central aperture 107 to allow the bird access to the nectar or birdseed. FIG. 6 additionally illustrates a pole aperture 119 which may be six sided or other number of sided in order to be connected to the central pole. The cover member 101 may also include a perch member 131 which extends around the periphery of the cover member 101 to provide a rod or rail for the birds to rest and is positioned at a spaced relationship with the side surface 109 by a support member 133 which may be an arm to support the perch member 131. FIG. 6 additionally illustrates an inner rib member 115 which extends around the periphery of the cover member 101 and a outer rib member 117 which may be positioned in a spaced relationship to the inner ribbed member 115 and may define a channel to interconnect with the base member 151 (not shown in FIG. 6).

FIG. 7 illustrates the base member 151 of the bird feeder 101 of the present invention and may include an outer wall 153 which may upwardly extend around the periphery of the base member 151 from the bottom 152 and cooperates and may lock with the inner rib member 115 and the outer rib member 117 in the channel 135. The interior surface of the outer wall 153 may include a connection member 161 which may include a substantially vertical groove 163 to position a divider member (not shown in FIG. 7). The connection member 161 may include a curved surface. FIG. 7 additionally illustrates a first inner wall 155 which may be in a spaced relationship to the outer wall 153 and extends upwards from the bottom 152 and may include an opposing connection member 161 which may include the substantially vertical groove 163 to position the divider member. The base member 151 may include a second inner wall 159 in a spaced relationship to the first inner wall 155 and extends upwards from the bottom 152. The outer wall 153 and the first inner wall 155 may be six sided or any other number of sides and may define a container 157 to store the nectar or sugar water for the birds to feed from. The first inner wall 155 and the second inner wall 159 may define a first ant moat 165 to prevent ants from entering the container 157. The base member 151 may include a finger member 156 which may be flexible to move to increase or decrease a friction fit with the central pole.

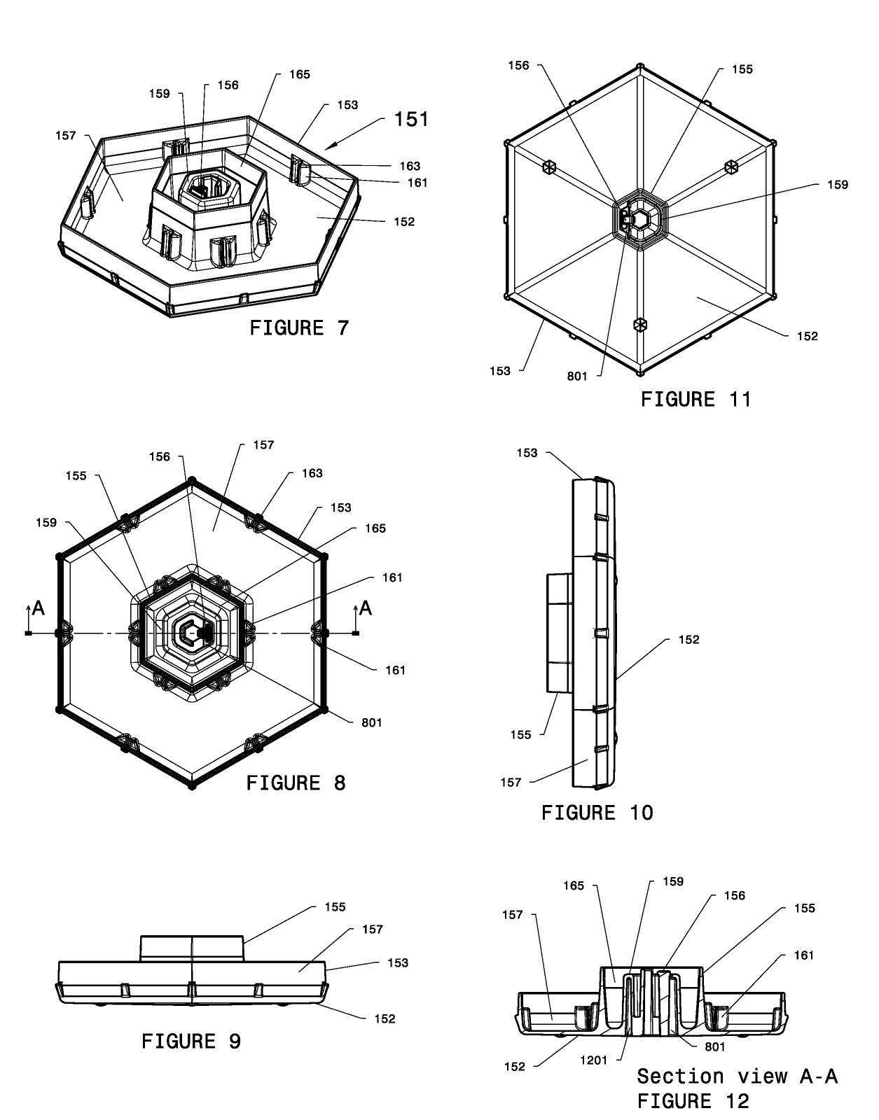

FIG. 8 illustrates the base member 151 of the bird feeder 101 of the present invention and may include an outer wall 153 which may upwardly extend around the periphery of the base member 151 from the bottom 152 and cooperates and may lock with the inner rib member 115 and the outer rib member 117 in the channel 135. The interior surface of the outer wall 153 may include a connection member 161 which may include a substantially vertical groove 163 to position a divider member (not shown in FIG. 8). The connection member 161 may include a curved surface. FIG. 8 additionally illustrates a first inner wall 155 which may be in a spaced relationship to the outer wall 153 and extends upwards from the bottom 152 and may include an opposing connection member 161 which may include the substantially vertical groove 163 to position the divider member. The base member 151 may include a second inner wall 159 in a spaced relationship to the first inner wall 155 and extends upwards from the bottom 152. The outer wall 153 and the first inner wall 155 may be six sided or any other number of sides and may define a container 157 to store the nectar or sugar water for the birds to feed from. The first inner wall 155 and the second inner wall 159 may define a first ant moat 165 to prevent ants from entering the container 157 and a drain aperture 801 as shown in FIG. 12.

FIG. 9 illustrates a bottom view of the base member 151 and illustrates the outer wall 153, the bottom 152 the container 157 and the first inner wall 155.

FIG. 10 illustrates a side view of the base member 151 and illustrates the outer wall 153, the bottom 152 the container 157 and the first inner wall 155.

FIG. 11 illustrates a lot in view of the base member 151 and illustrates the outer wall 153, the bottom 152. the finger member 156, the first inner wall 155 and the second inner wall 159 and drain aperture 801.

FIG. 12 illustrates the base member 151 of the bird feeder 101 of the present invention and may include an outer wall 153 which may upwardly extend around the periphery of the base member 151 from the bottom 152 and cooperates and may lock with the inner rib member 115 and the outer rib member 117 in the channel 135. The interior surface of the outer wall 153 may include a connection member 161 which may include a substantially vertical groove 163 to position a divider member (not shown in FIG. 12). The connection member 161 may include a curved surface. FIG. 8 additionally illustrates a first inner wall 155 which may be in a spaced relationship to the outer wall 153 and extends upwards from the bottom 152 and may include an opposing connection member 161 which may include the substantially vertical groove 163 to position the divider member. The base member 151 may include a second inner wall 159 in a spaced relationship to the first inner wall 155 and extends upwards from the bottom 152. The outer wall 153 and the first inner wall 155 may be six sided or any other number of sides and may define a container 157 to store the nectar or sugar water for the birds to feed from. The first inner wall 155 and the second inner wall 159 may define a first ant moat 165 to prevent ants from entering the container 157. A female hole 1201 is provided to accept male part of 187,181 of member 180 from FIG. 22. Element 159 is lower than wall 155 in inner ant moat to allow excess water to drain through holes 801 in FIG. 8, FIG. 11 and FIG. 12.

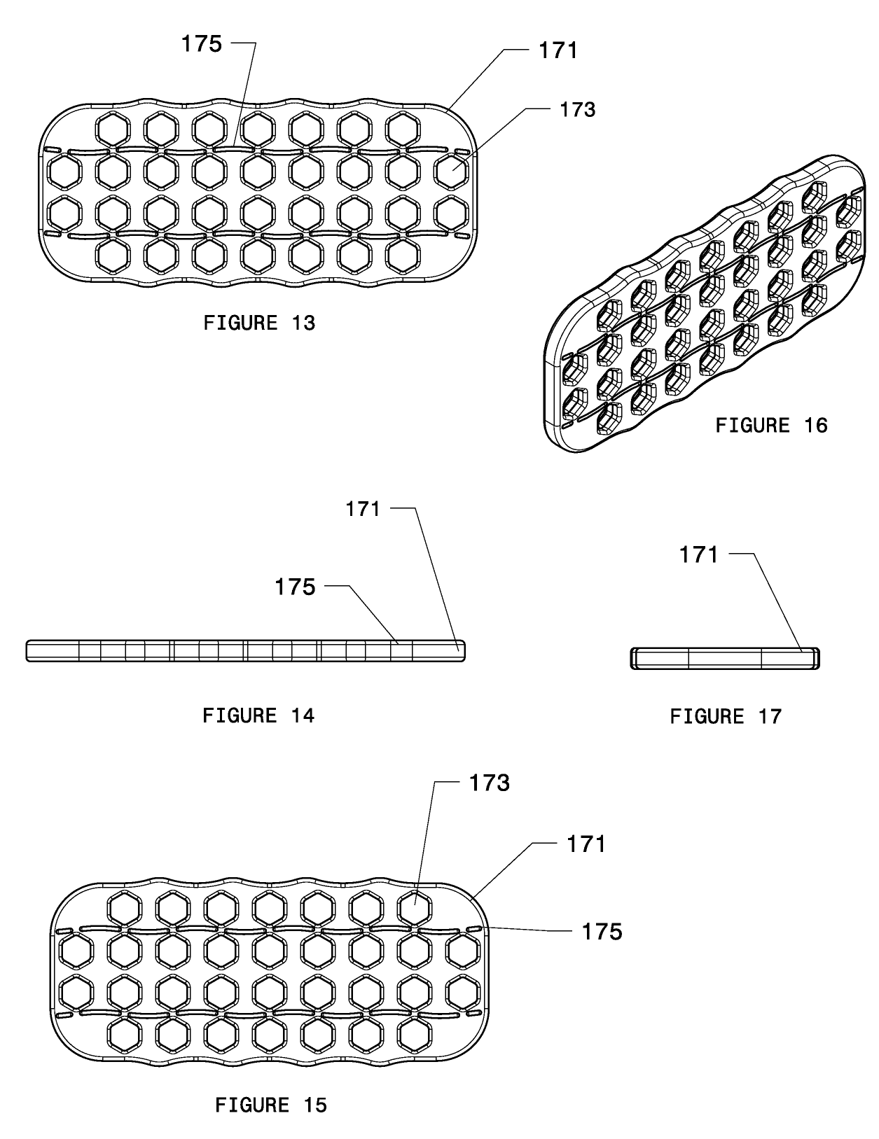

FIG. 13 illustrates a divider member 171 which may extend between a connecting member 161. The ends of the divider member 171 may cooperate with the groove 163. The divider member may include apertures 173 which extend through the divider member 171 in order to allow the water and sugar to mix. And the divider member may include a indicia 175 to indicate a proper water level. The divider member 171 may have sugar added to the top edge of the divider member 171.

FIG. 14 illustrates a front view of the divider member 171 and illustrates the aperture 173 in phantom line.

FIG. 15 illustrates a bottom view of the divider member 171 and illustrates the aperture 173 and the indicia 175.

FIG. 16 illustrates an isometric view of the divider member 171 and illustrates the aperture 173 and the indicia 175.

FIG. 17 illustrates an end view of the divider member 171.

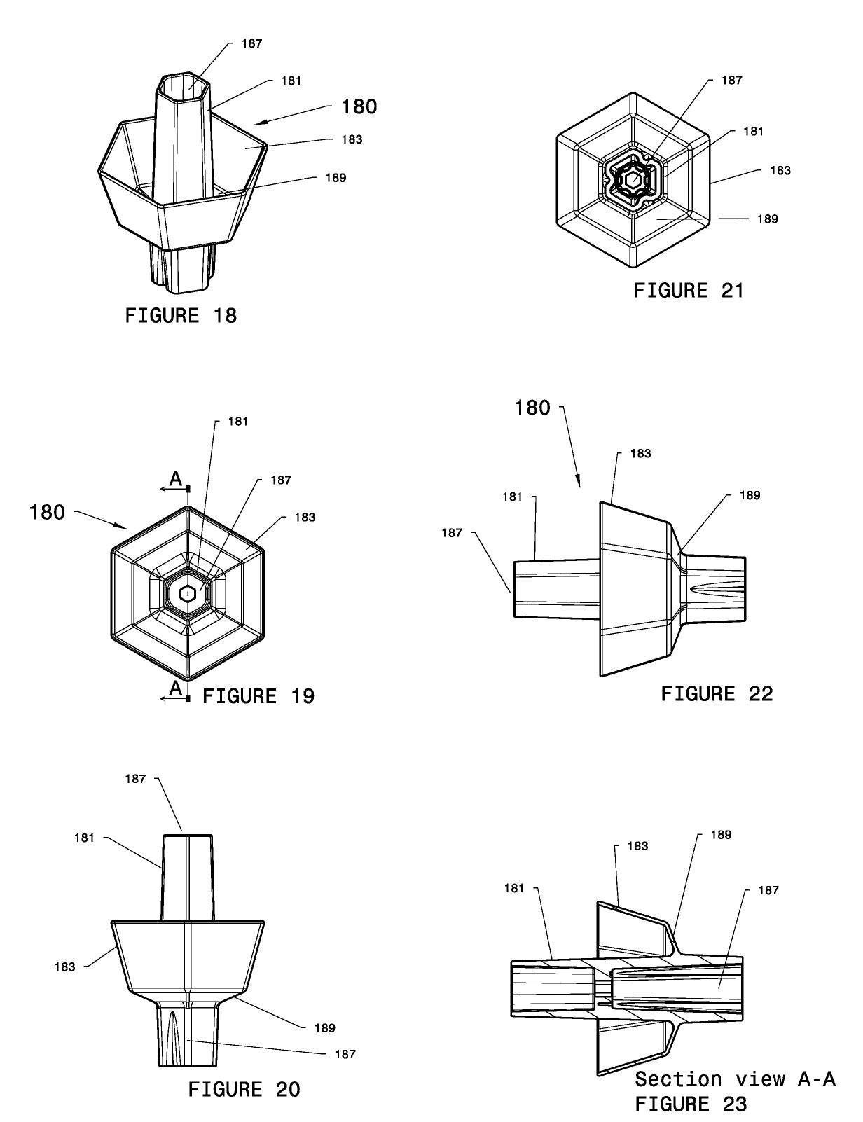

FIGS. 18-23 illustrates the support member of the present invention.

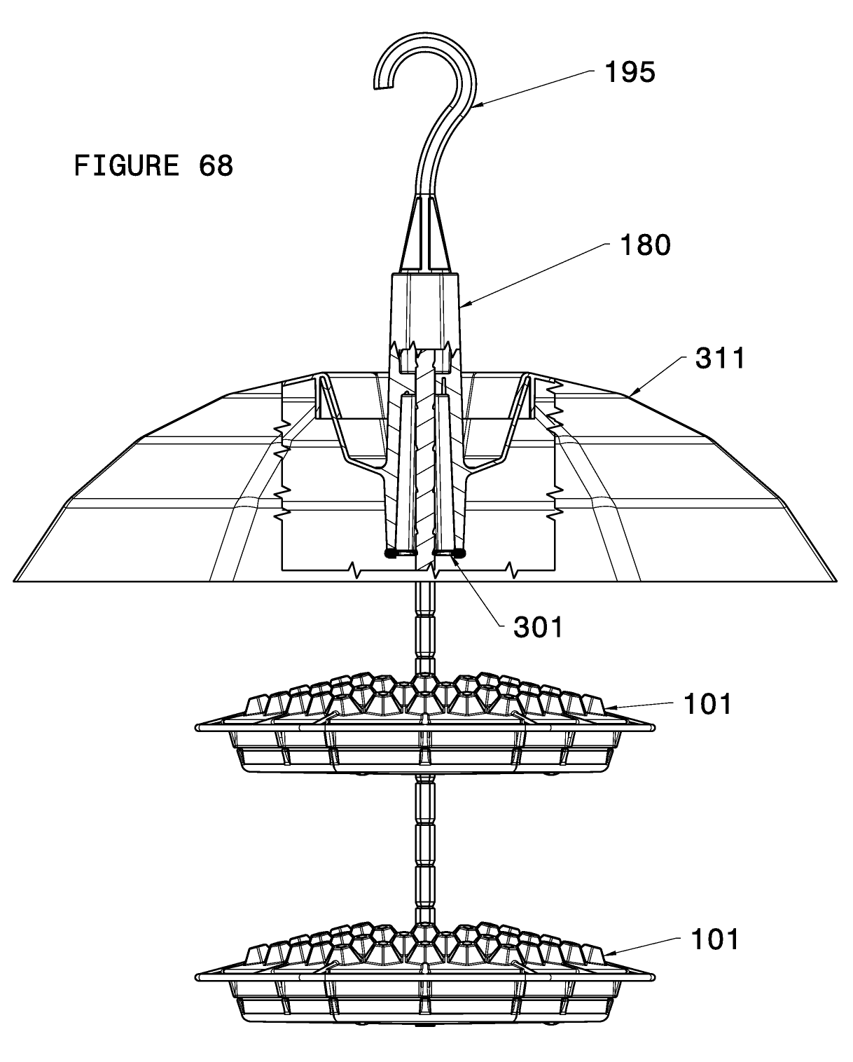

FIG. 18 illustrates the support member 180 of the present invention, and the support member 180 may support the base member 151 and the cover member 101 and may connect to a pole member. The support member 180 may support the protective shield 311 in FIG. 68. The support member 180 may include an inward inclined inner wall 181 which may extend the length of the support member 180 and an outward inclined outer wall 183 which cooperates with the inward inclined inner wall 181 to define a peripheral channel 185. The peripheral channel 185 may be filled with water in order to form a second ant moat to deter ants from reaching the nectar. The outer wall 183 and inner wall 181 may be six sided or other numbers of sides. The support member 180 may include a central aperture 187 to cooperate with the pole member. The upper section of the inner wall 181 cooperates with the bottom of the base member 151 in order to support the cover member 101 and the base member 151. The inner wall 181 may be connected with the outer wall 183 by a bottom member 189.

FIG. 19 illustrates the support member 180 of the present invention, and the support member 180 may support the base member 151 and the cover member 101 and may connect to a pole member. The support member 180 may include an inward inclined inner wall 181 which may extend the length of the support member 180 and an outward inclined outer wall 183 which cooperates with the inward inclined inner wall 181 to define a peripheral channel 185. The peripheral channel 185 may be filled with water in order to form a second ant moat to deter ants from reaching the nectar. The outer wall 183 and inner wall 181 may be six sided or other numbers of sides. The support member 180 may include a central aperture 187 to cooperate with the pole member. The upper section of the inner wall 181 cooperates with the bottom of the base member 151 in order to support the cover member 101 and the base member 151. The inner wall 181 may be connected with the outer wall 183 by a bottom member 189.

FIG. 20 illustrates the support member 180 of the present invention, and the support member 180 may support the base member 151 and the cover member 101 and may connect to a pole member. The support member 180 may include an inward inclined inner wall 181 which may extend the length of the support member 180 and an outward inclined outer wall 183 which cooperates with the inward inclined inner wall 181 to define a peripheral channel 185. The peripheral channel 185 may be filled with water in order to form a second ant moat to deter ants from reaching the nectar. The outer wall 183 and inner wall 181 may be six sided or other numbers of sides. The support member 180 may include a central aperture 187 to cooperate with the pole member. The upper section of the inner wall 181 cooperates with the bottom of the base member 151 in order to support the cover member 101 and the base member 151. The inner wall 181 may be connected with the outer wall 183 by a bottom member 189.

FIG. 21 illustrates the support member 180 of the present invention, and the support member 180 may support the base member 151 and the cover member 101 and may connect to a pole member. The support member 180 may include an inward inclined inner wall 181 which may extend the length of the support member 180 and an outward inclined outer wall 183 which cooperates with the inward inclined inner wall 181 to define a peripheral channel 185. The peripheral channel 185 may be filled with water in order to form a second ant moat to deter ants from reaching the nectar. The outer wall 183 and inner wall 181 may be six sided or other numbers of sides. The support member 180 may include a central aperture 187 to cooperate with the pole member. The upper section of the inner wall 181 cooperates with the bottom of the base member 151 in order to support the cover member 101 and the base member 151. The inner wall 181 may be connected with the outer wall 183 by a bottom member 189.

FIG. 22 illustrates the support member 180 of the present invention, and the support member 180 may support the base member 151 and the cover member 101 and may connect to a pole member. The support member 180 may include an inward inclined inner wall 181 which may extend the length of the support member 180 and an outward inclined outer wall 183 which cooperates with the inward inclined inner wall 181 to define a peripheral channel 185. The peripheral channel 185 may be filled with water in order to form a second ant moat to deter ants from reaching the nectar. The outer wall 183 and inner wall 181 may be six sided or other numbers of sides. The support member 180 may include a central aperture 187 to cooperate with the pole member. The upper section of the inner wall 181 cooperates with the bottom of the base member 151 in order to support the cover member 101 and the base member 151. The inner wall 181 may be connected with the outer wall 183 by a bottom member 189.

FIG. 23 illustrates the support member 180 of the present invention, and the support member 180 may support the base member 151 and the cover member 101 and may connect to a pole member. The support member 180 may include an inward inclined inner wall 181 which may extend the length of the support member 180 and an outward inclined outer wall 183 which cooperates with the inward inclined inner wall 181 to define a peripheral channel 185. The peripheral channel 185 may be filled with water in order to form a second ant moat to deter ants from reaching the nectar. The outer wall 183 and inner wall 181 may be six sided or other numbers of sides. The support member 180 may include a central aperture 187 to cooperate with the pole member. The upper section of the inner wall 181 cooperates with the bottom of the base member 151 in order to support the cover member 101 and the base member 151. The inner wall 181 may be connected with the outer wall 183 by a bottom member 189.

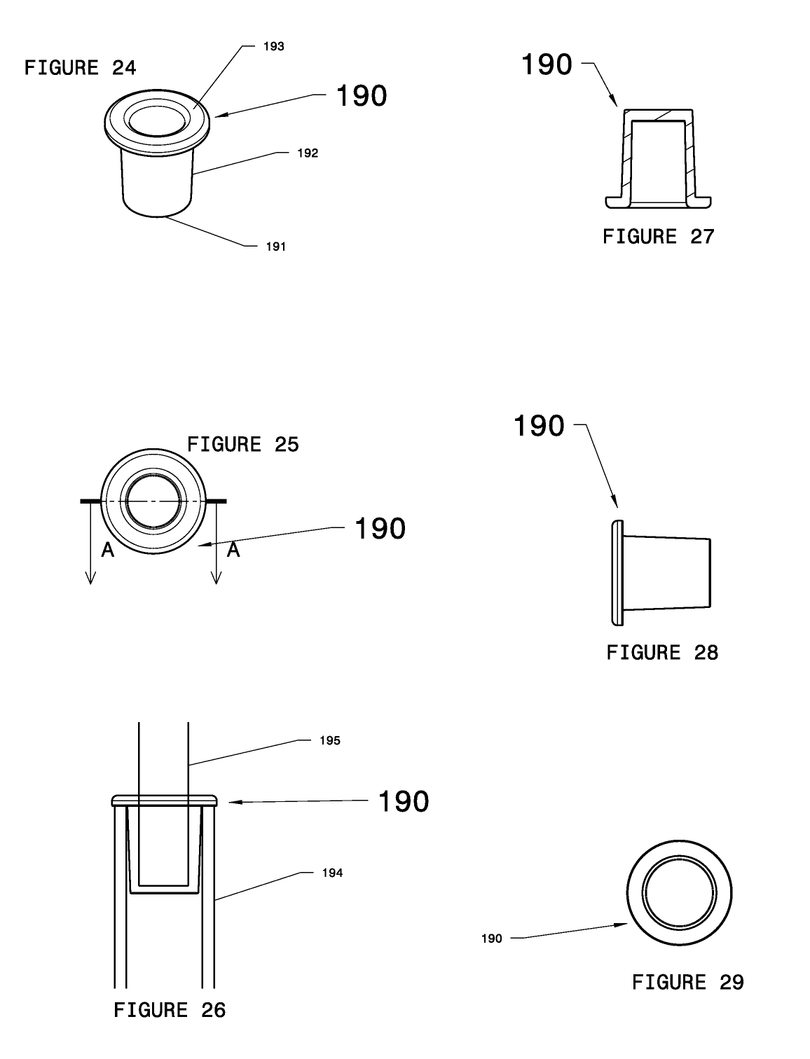

FIGS. 24-29 illustrate a bearing member of the present invention.

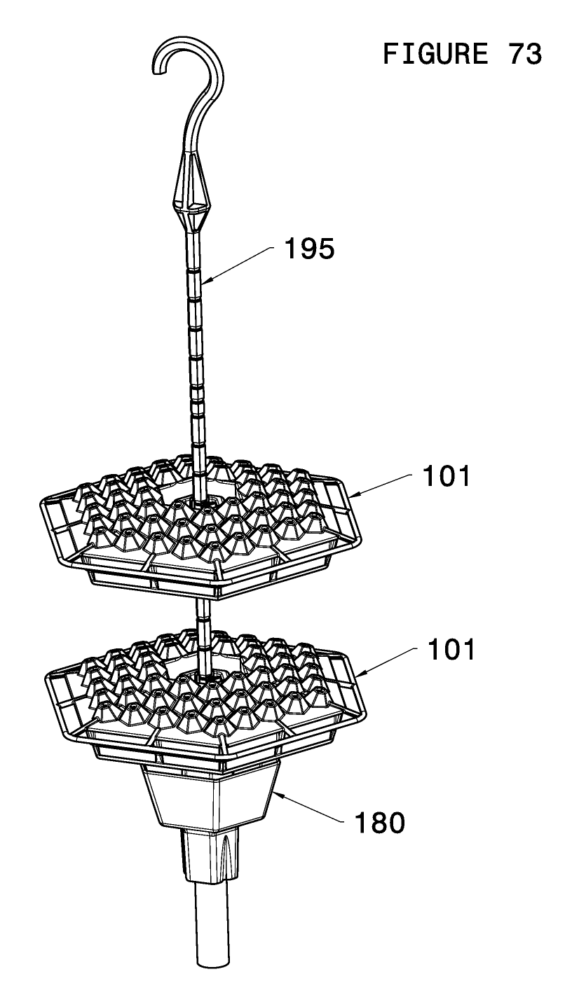

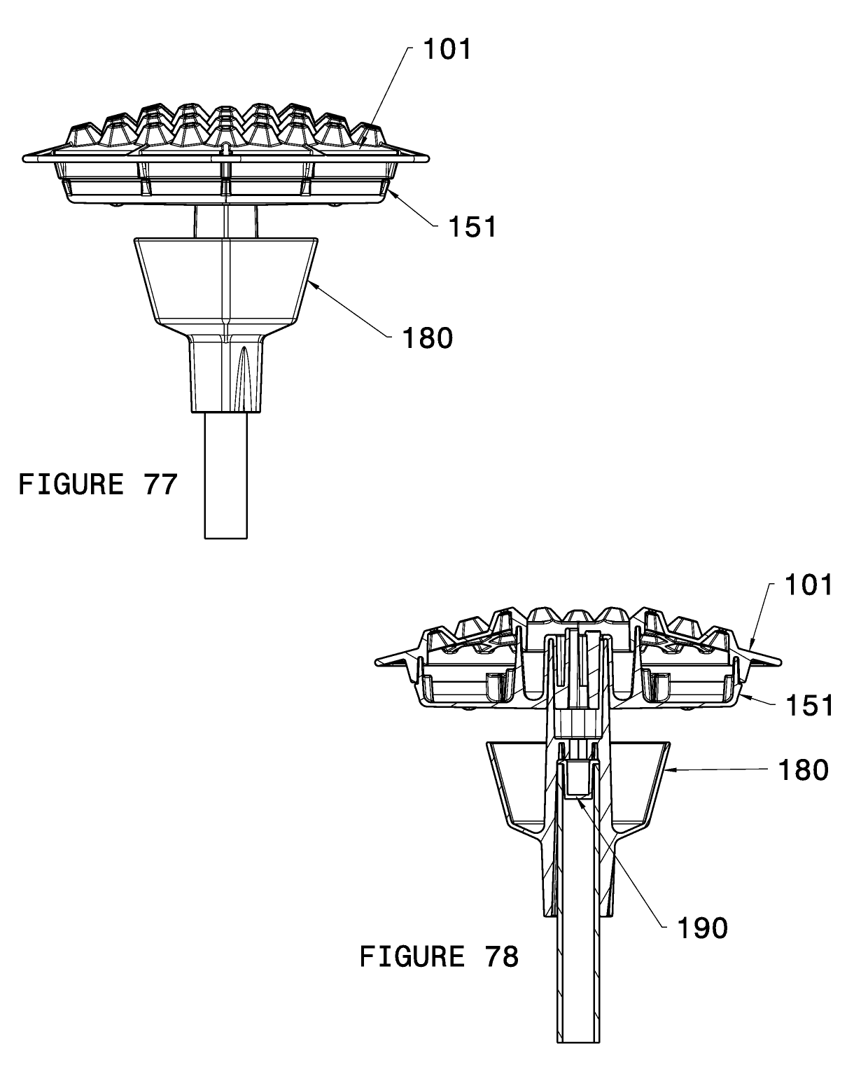

The bearing member 190 prevents the hanger 195 from falling into the pole which is hollow shown in FIG. 77 (also shown in assembly FIG. 73)

FIG. 24 illustrates the bearing member 190 which may include a cylindrical side to 192 which may be connected to a peripheral lip 193 and may be connected to a bottom 191.

FIG. 25 illustrates the bearing member 190 which may include a cylindrical side to 192 which may be connected to a peripheral lip 193 and may be connected to a bottom 191.

FIG. 26 illustrates the bearing member 190 which may include a cylindrical side to 192 which may be connected to a peripheral lip 193 and may be connected to a bottom 191. FIG. 26 illustrates that the bearing member 190 may cooperate with the pole member 194 and the hangar member 195.

FIG. 27 illustrates the bearing member 190 which may include a cylindrical side to 192 which may be connected to a peripheral lip 193 and may be connected to a bottom 191.

FIG. 28 illustrates the bearing member 190 which may include a cylindrical side to 192 which may be connected to a peripheral lip 193 and may be connected to a bottom 191.

FIG. 29 illustrates the bearing member 190 which may include a cylindrical side to 192 which may be connected to a peripheral lip 193 and may be connected to a bottom 191.

FIGS. 30-35 illustrates the hangar member 195 of the present invention and the hangar member 195 may be used to position the cover member 101 and the base member 151 in position so that birds may access to the feeder.

FIG. 30 illustrates the hangar member 195 which may include a hook section 196 which may be positioned at one end of the hangar member 195 to hook a branch or wire to position the bird feeder and may include a shaft member 198 which may be a six sided shaft. The shaft member may include a reduced dimension/diameter section 197 in order to accept fastening devices 301 and also flexible tab 156 to fastening support member 180 to the shaft member 198 (not shown in FIG. 30).

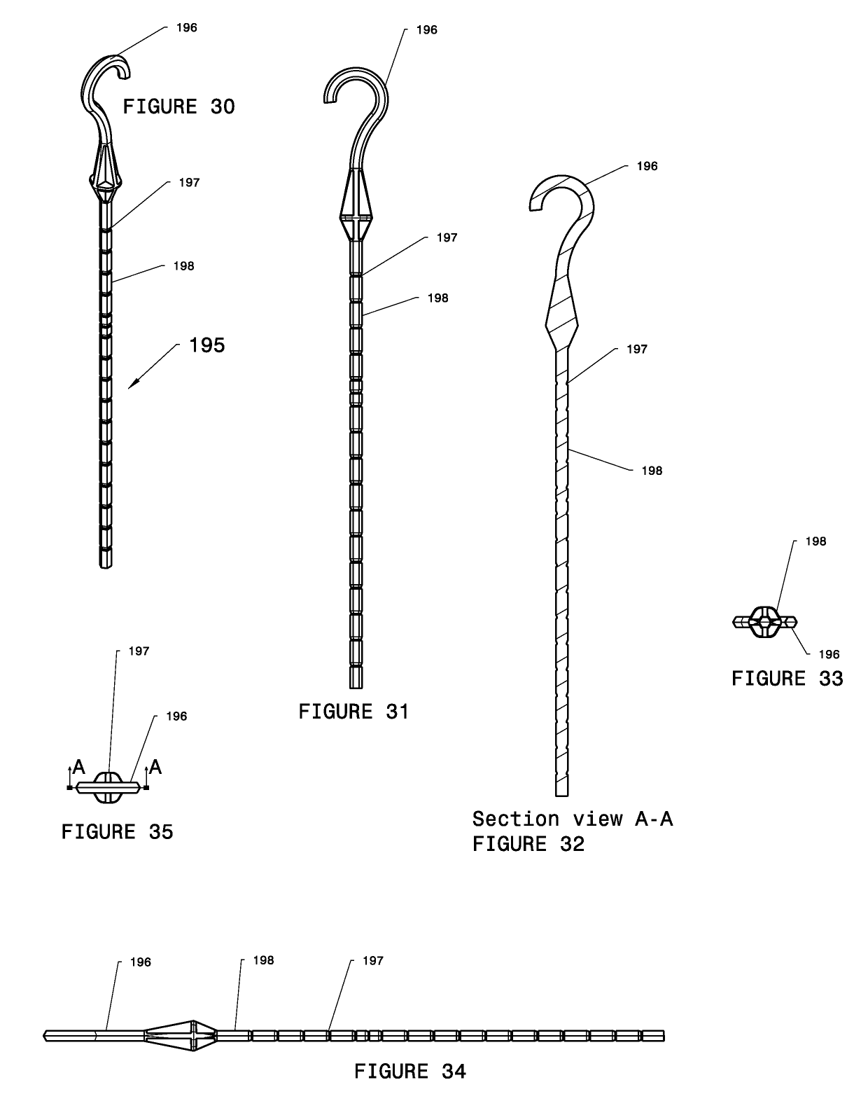

FIG. 31 illustrates the hangar member 195 which may include a hook section 196 which may be positioned at one end of the hangar member 195 to hook a branch or wire to position the bird feeder and may include a shaft member 198 which may be a six sided shaft. The shaft member may include a reduced dimension/diameter section 197 in order to accept fastening devices to fastening support member 180 to the shaft member 198 (not shown in FIG. 31).

FIG. 32 illustrates the hangar member 195 which may include a hook section 196 which may be positioned at one end of the hangar member 195 to hook a branch or wire to position the bird feeder and may include a shaft member 198 which may be a six sided shaft. The shaft member may include a reduced dimension/diameter section 197 in order to accept fastening devices to fastening support member 180 to the shaft member 198 (not shown in FIG. 32).

FIG. 33 illustrates a bottom view of the hangar member 195 which may include a shaft member 198 and a hook member 196.

FIG. 34 illustrates the hangar member 195 which may include a hook section 196 which may be positioned at one end of the hangar member 195 to hook a branch or wire to position the bird feeder and may include a shaft member 198 which may be a six sided shaft. The shaft member may include a reduced dimension/diameter section 197 in order to accept fastening devices to fastening support member 180 to the shaft member 198 (not shown in FIG. 34).

FIG. 35 illustrates a bottom view of the hangar member 195 which may include a shaft member 198 and a hook member 196.

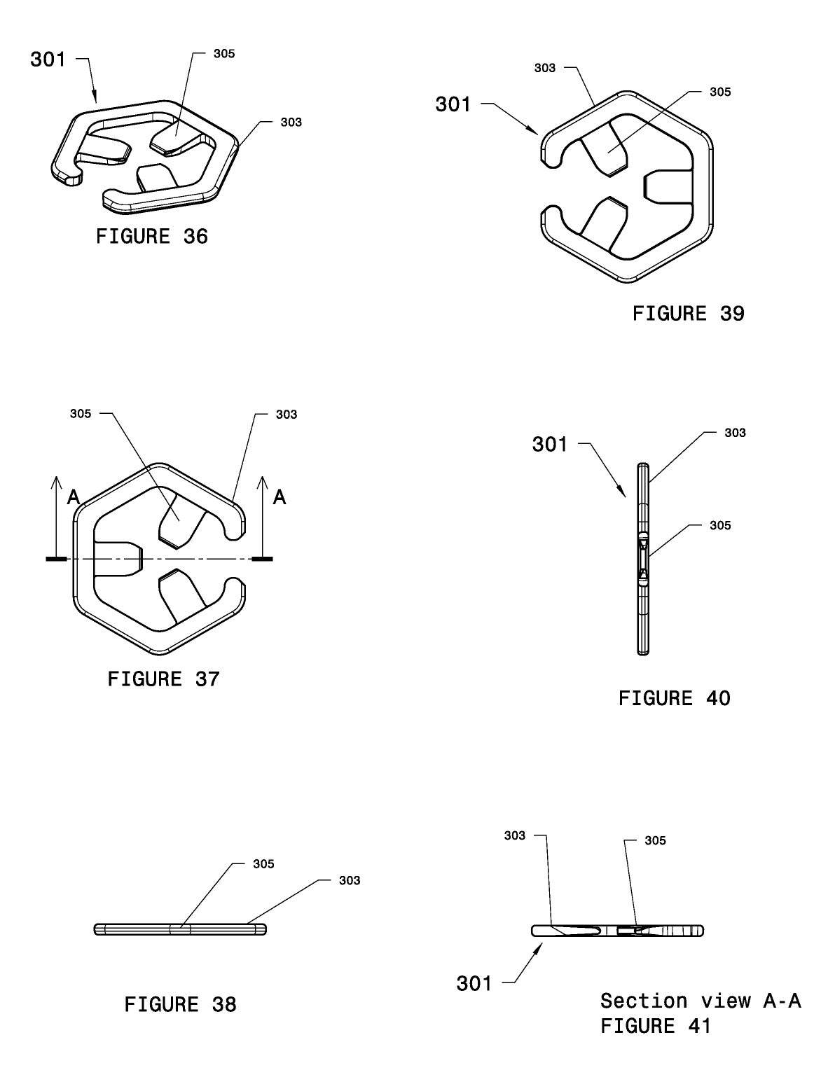

FIGS. 36-41 illustrate the hangar fastening device of the present invention.

The hangar fastening device 301 as illustrated in FIG. 36 may include a noncontinuous peripheral frame member 303 which may support arm members 305 which may extend inward and radially to engage the reduced diameter section 197 of the hangar member 195. The noncontinuous peripheral frame member 303 may be illustrated as a noncontinuous six sided frame member but could be circular or any number of sided frame member.

The hangar fastening device 301 as illustrated in FIG. 37 may include a noncontinuous peripheral frame member 303 which may support arm members 305 which may extend inward and radially to engage the reduced diameter section 197 of the hangar member 195. The noncontinuous peripheral frame member 303 may be illustrated as a noncontinuous six sided frame member but could be circular or any number of sided frame member.

The hangar fastening device 301 as illustrated in FIG. 38 may include a noncontinuous peripheral frame member 303 which may support arm members 305 which may extend inward and radially to engage the reduced diameter section 197 of the hangar member 195. The noncontinuous peripheral frame member 303 may be illustrated as a noncontinuous six sided frame member but could be circular or any number of sided frame member.

The hangar fastening device 301 as illustrated in FIG. 39 may include a noncontinuous peripheral frame member 303 which may support arm members 305 which may extend inward and radially to engage the reduced diameter section 197 of the hangar member 195. The noncontinuous peripheral frame member 303 may be illustrated as a noncontinuous six sided frame member but could be circular or any number of sided frame member.

The hangar fastening device 301 as illustrated in FIG. 40 may include a noncontinuous peripheral frame member 303 which may support arm members 305 which may extend inward and radially to engage the reduced diameter section 197 of the hangar member 195. The noncontinuous peripheral frame member 303 may be illustrated as a noncontinuous six sided frame member but could be circular or any number of sided frame member.

The hangar fastening device 301 as illustrated in FIG. 41 may include a noncontinuous peripheral frame member 303 which may support arm members 305 which may extend inward and radially to engage the reduced diameter section 197 of the hangar member 195. The noncontinuous peripheral frame member 303 may be illustrated as a noncontinuous six sided frame member but could be circular or any number of sided frame member.

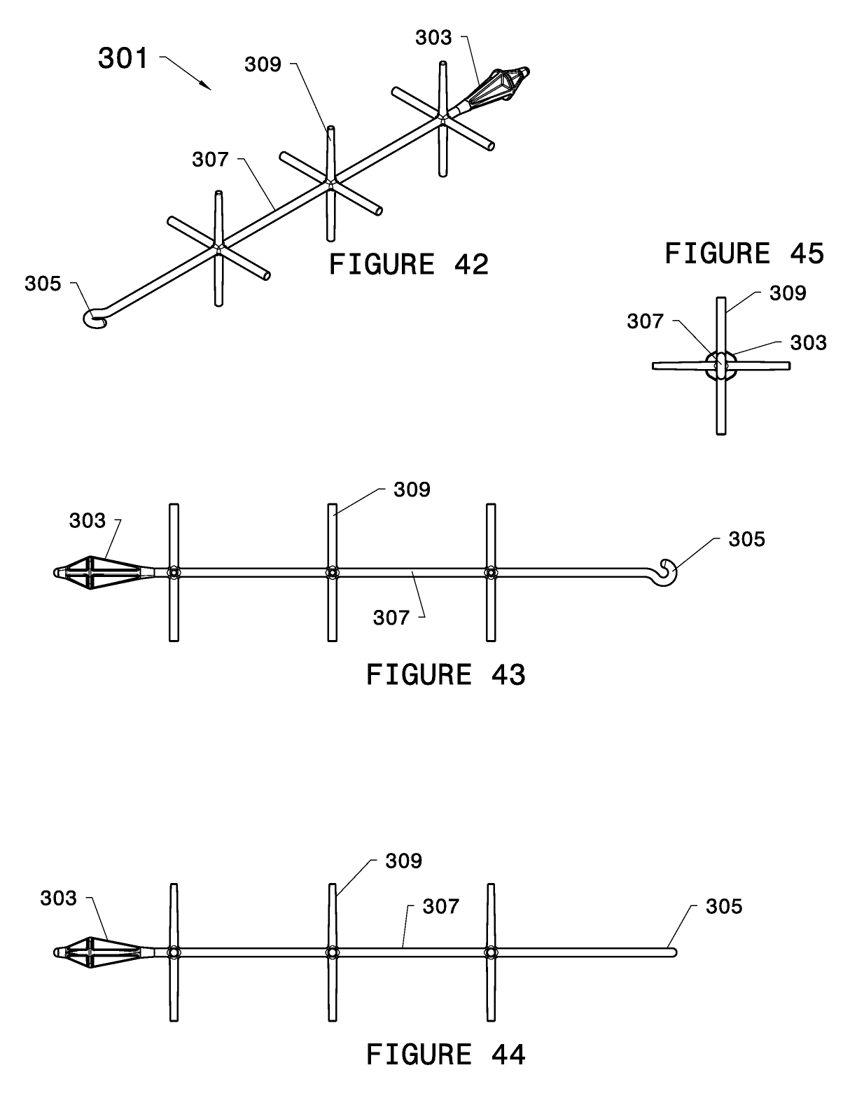

FIGS. 42-45 illustrate the perch member 301 of the present invention.

FIG. 42 illustrates the perch member 301 which may include a handle member 303 at one end of the perch member 301 and a hook member 305 at opposing end of the perch member 301. The hook member 305 may be used to hook a branch or other object to provide a perch for birds. The perch member 301 may include radially extending arms 309 which may be positioned at different locations along the central shaft 307.

FIG. 43 illustrates the perch member 301 which may include a handle member 303 at one end of the perch member 301 and a hook member 305 at opposing end of the perch member 301. The hook member 305 may be used to hook a branch or other object to provide a perch for birds. The perch member 301 may include radially extending arms 309 which may be positioned at different locations along the central shaft 307.

FIG. 44 illustrates the perch member 301 which may include a handle member 303 at one end of the perch member 301 and a hook member 305 at opposing end of the perch member 301. The hook member 305 may be used to hook a branch or other object to provide a perch for birds. The perch member 301 may include radially extending arms 309 which may be positioned at different locations along the central shaft 307.

FIG. 45 illustrates the perch member 301. The perch member 301 may include radially extending arms 309 which may be positioned at different locations along the central shaft 307.

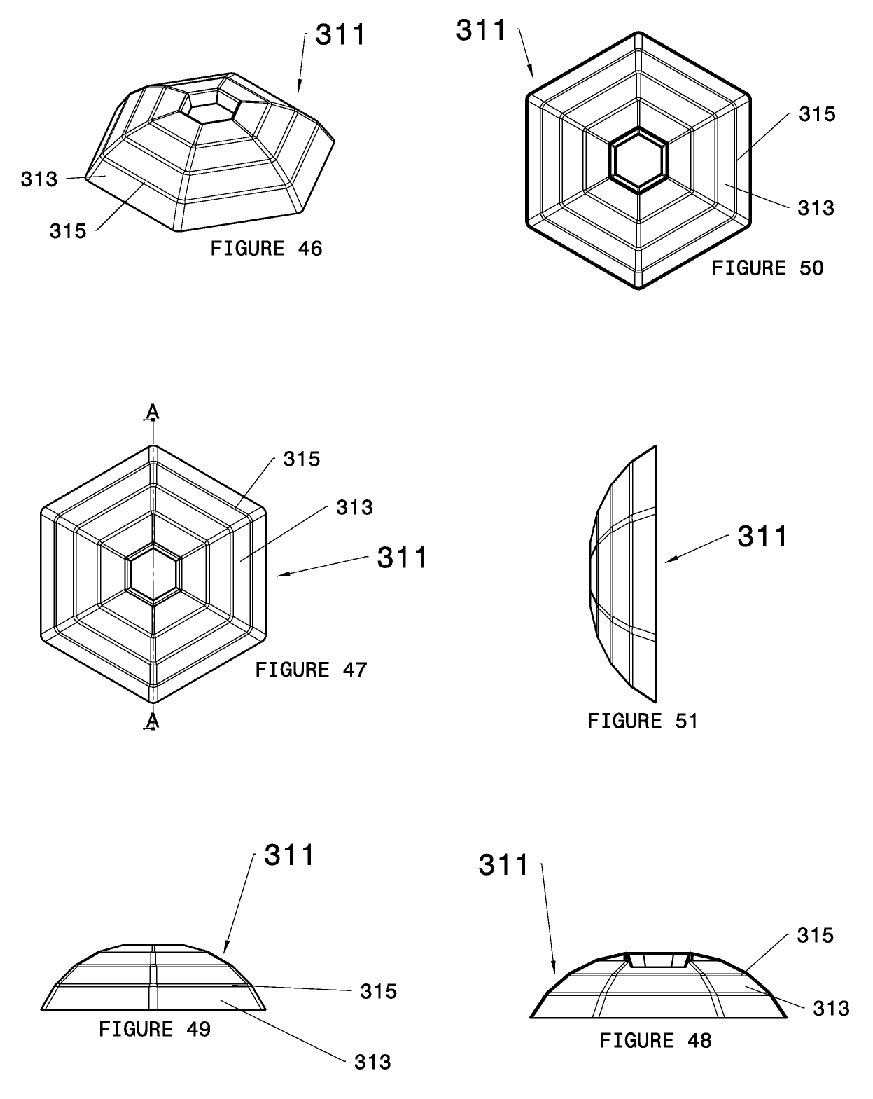

FIGS. 46-51 illustrate the protective member 311 which prevents rain snow and other objects from falling into the feeder and cooperates with the support member 180 support. The protective member 311 includes a inclined surface 313 which may include an ant moat 315 which may extend around the periphery of the protective member 311. The protective member 311 may have an ant moat similar to ant moat 315.

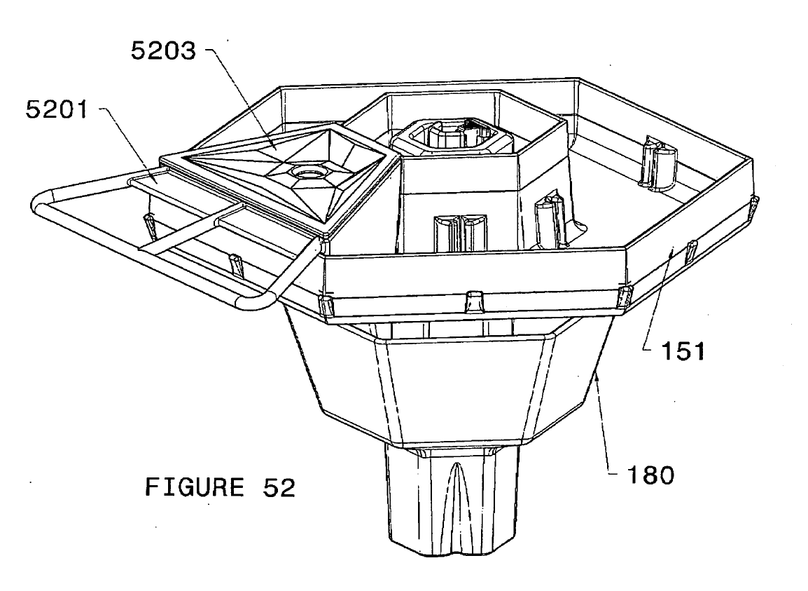

FIG. 52 illustrates the support member 180, the base member 151, the tray member 5201 and cover member 5203.

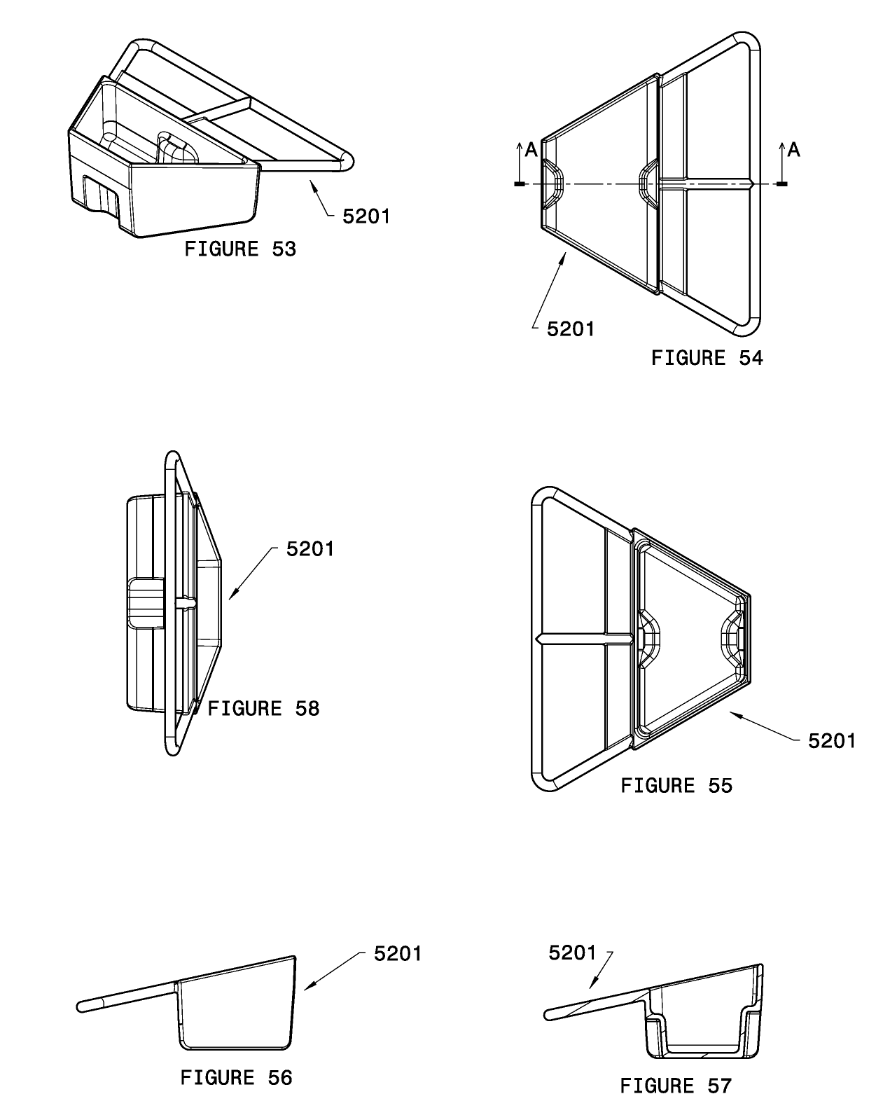

FIG. 53 illustrates a perspective view of the tray member 5201.

FIG. 54 illustrates a rearview of the tray member 5201.

FIG. 55 illustrates a front view of the tray member 5201.

FIG. 56 illustrates a bottom view of the tray member 5201.

FIG. 57 illustrates a sectional view of the tray member 5201.

FIG. 58 illustrates a side view of the tray member 5201.

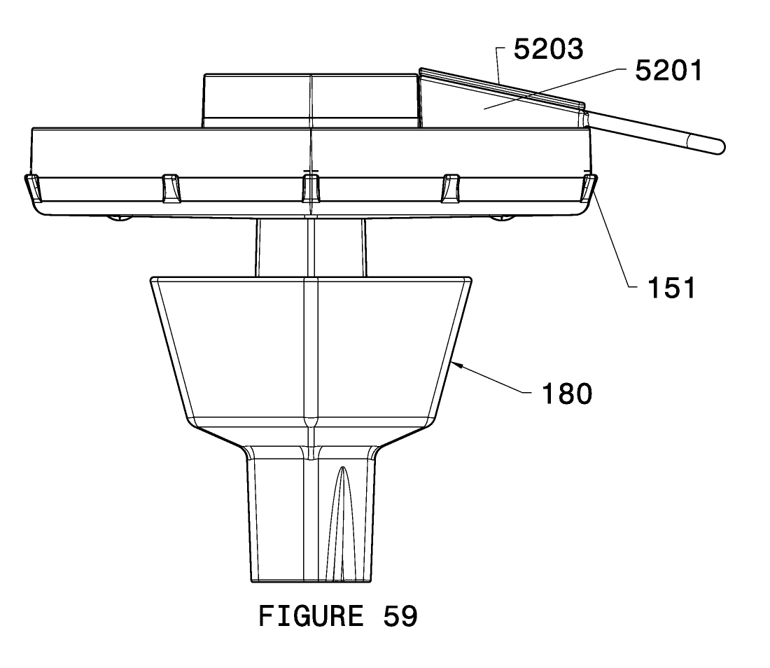

FIG. 59 illustrates the base member 151, the support member 180, the tray cover member 5203 and the tray member 5201

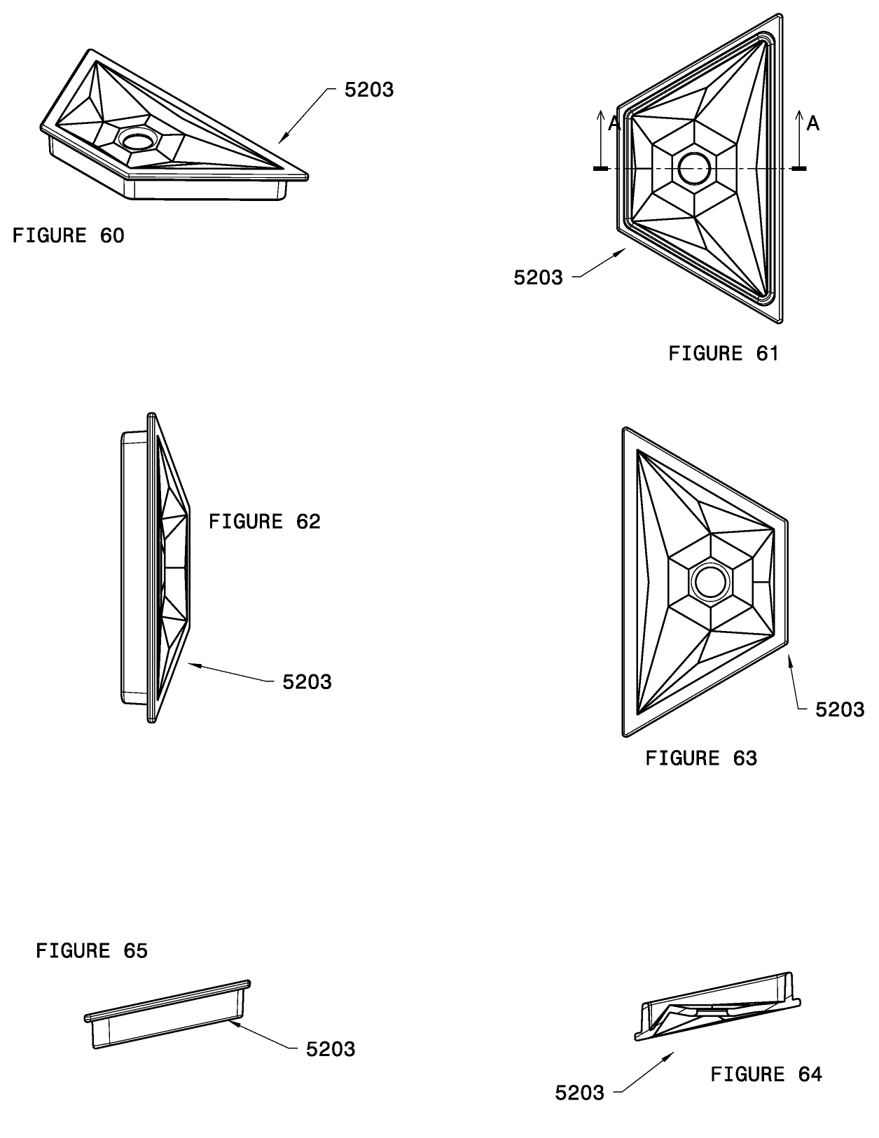

FIG. 60 illustrates a perspective view for a cover 5203 for the tray member 5201.

FIG. 61 illustrates a rearview for the cover 5203.

FIG. 62 illustrates a side for the cover 5203.

FIG. 63 illustrates a front view for the cover 5203.

FIG. 64 illustrates a sectional view for the cover 5203.

FIG. 65 illustrates a bottom view for the cover 5203.

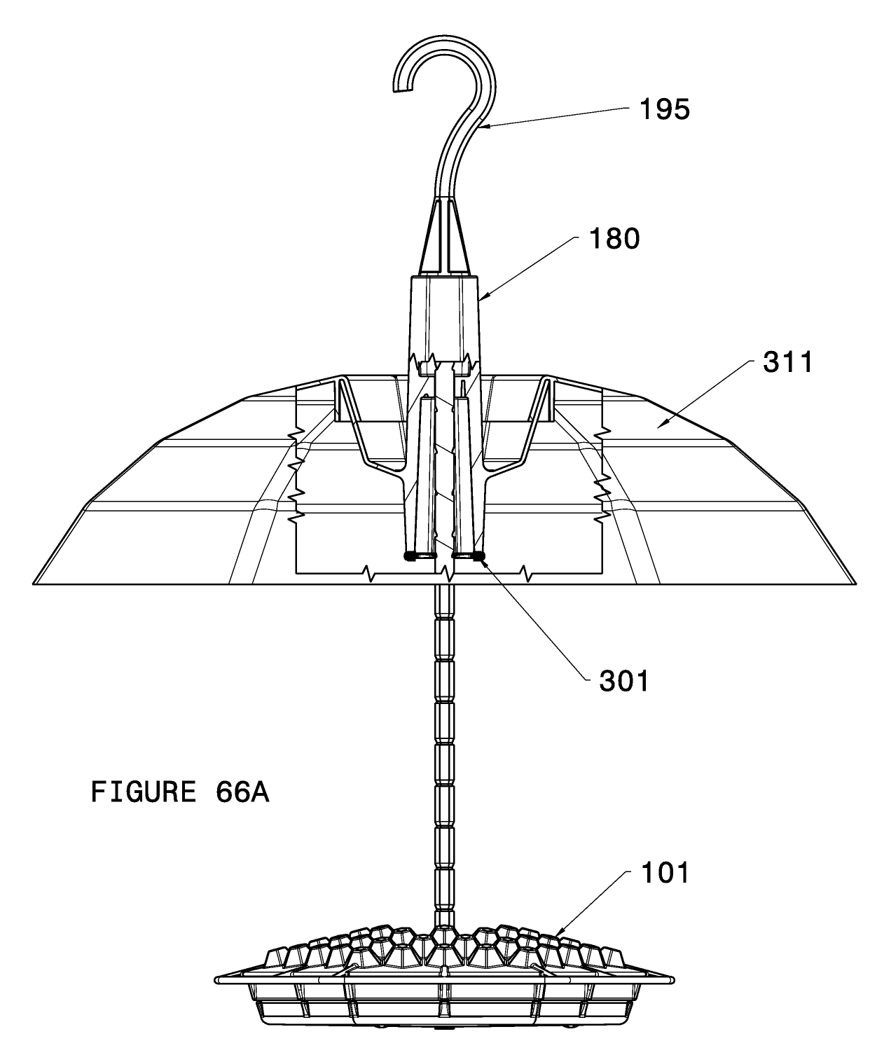

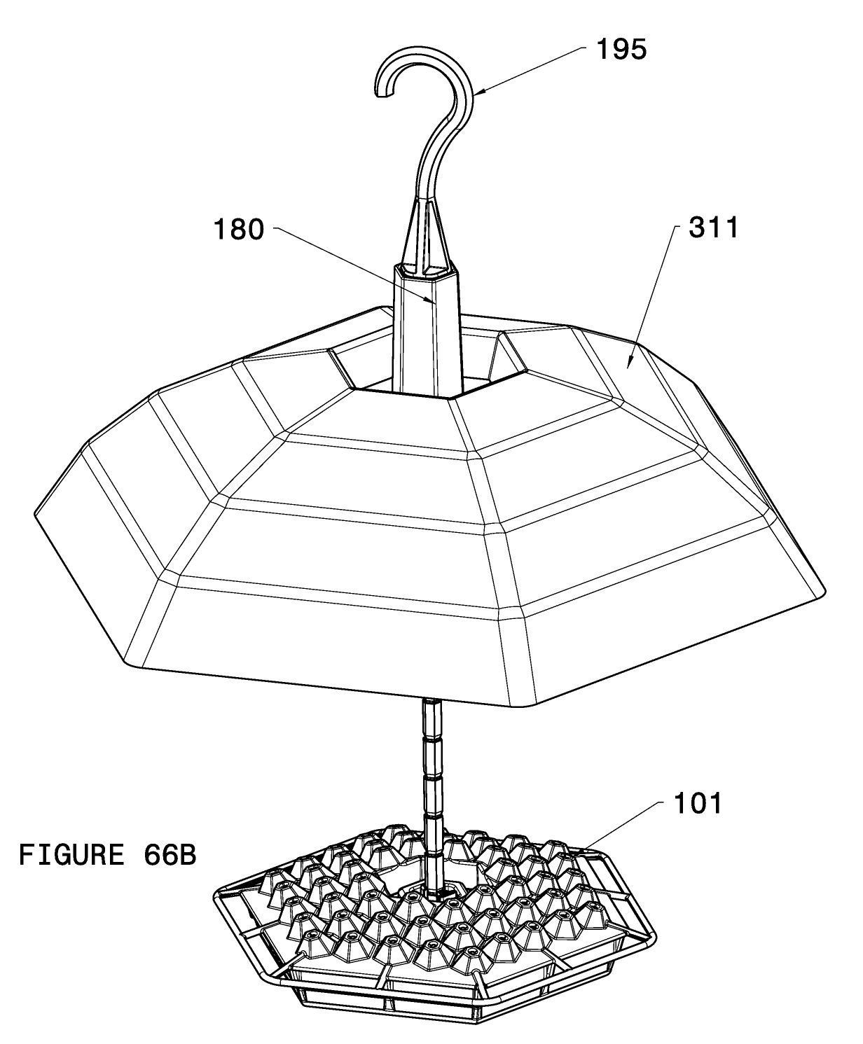

FIG. 66a illustrates the cover member 101, the hangar member 195, the support member 180, hanger fastening device 301 and the protective member 311.

FIG. 66b illustrates the cover member 101, the hangar member 195, the support member 180, and the protective member 311.

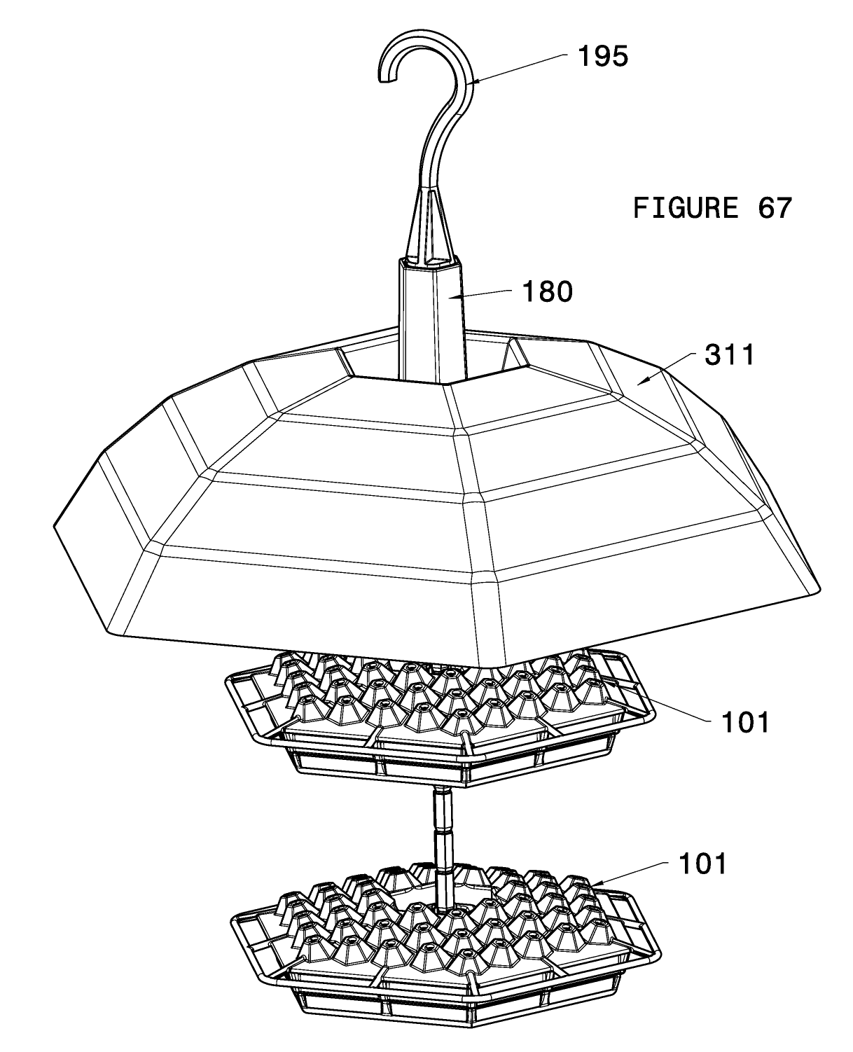

FIG. 67 illustrates a first and second cover member 101, the hangar member 195, the support member 180 and the protective member 311.

FIG. 68 illustrates a first and second cover member 101, the hangar member 195, the support member 180, hanger fastening device 301 and the protective member 311.

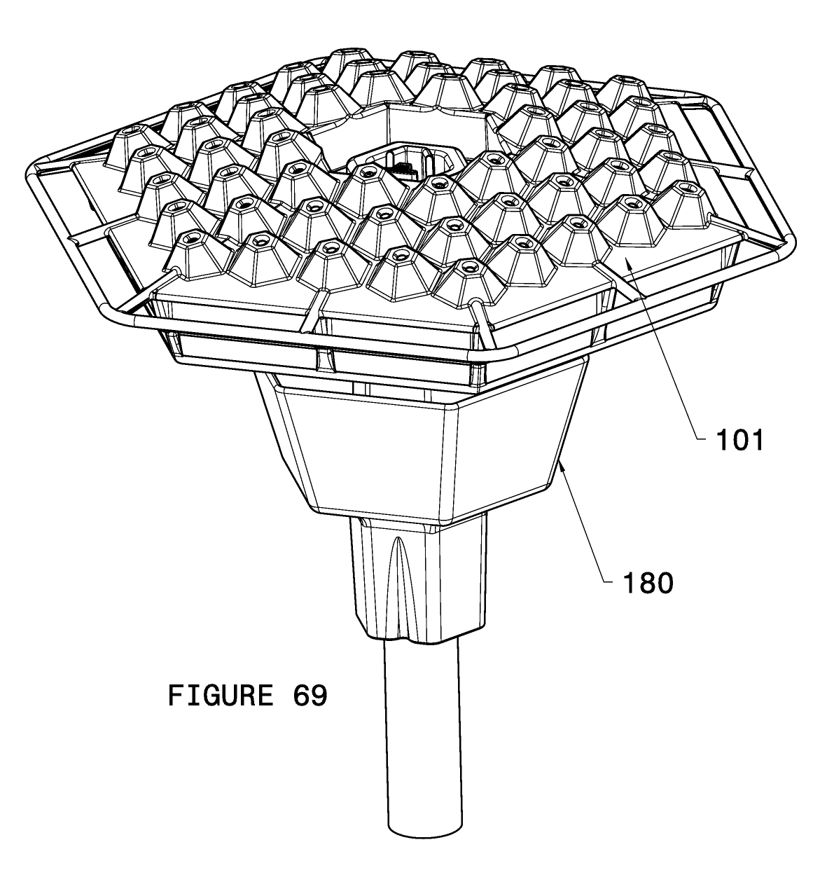

FIG. 69 illustrates the base member 101 and the support member 180 on a pole

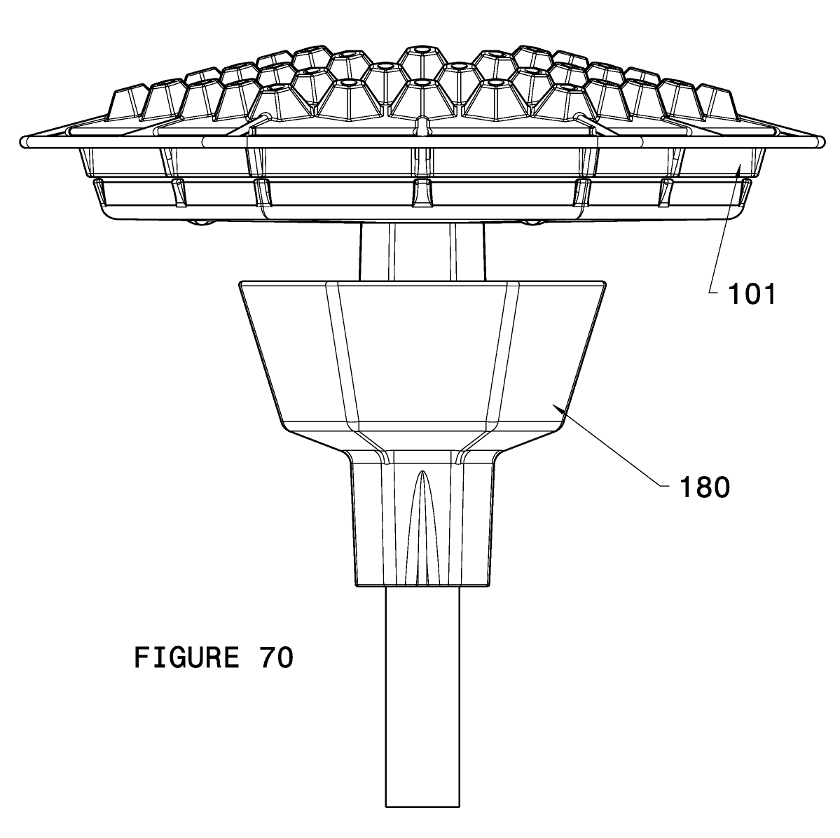

FIG. 70 illustrates the base member 101 and the support member 180 on a pole.

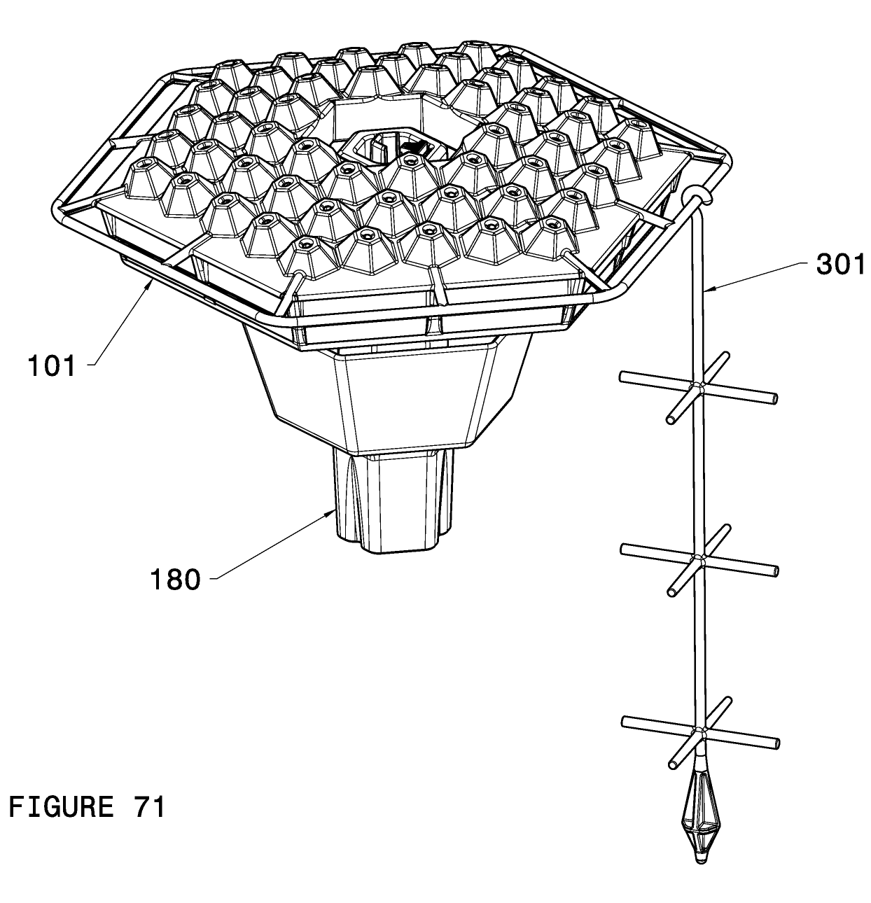

FIG. 71 illustrates the base member connected to the hangar fastening device 301 and the support member 180.

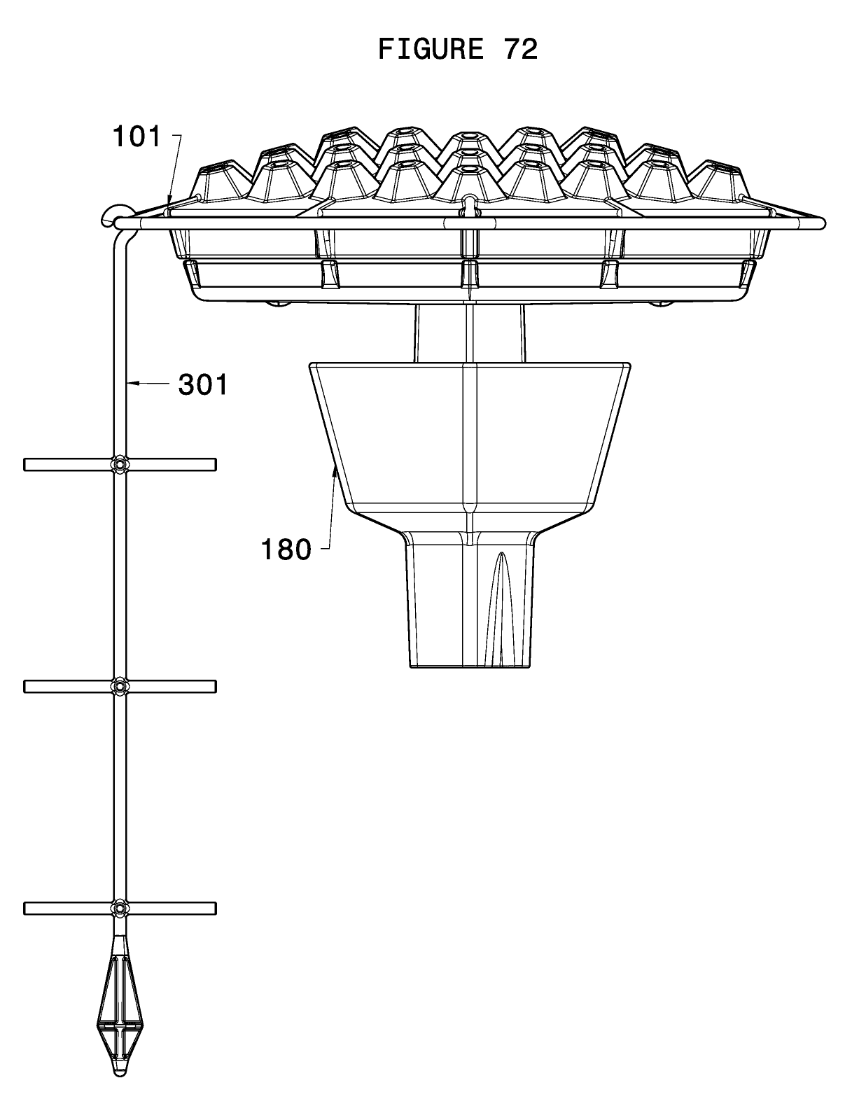

FIG. 72 illustrates the base member connected to the hangar fastening device 301 and the support member 180.

FIG. 73 illustrates the first and second cover member 101, the support member 180 and the hangar member 195.

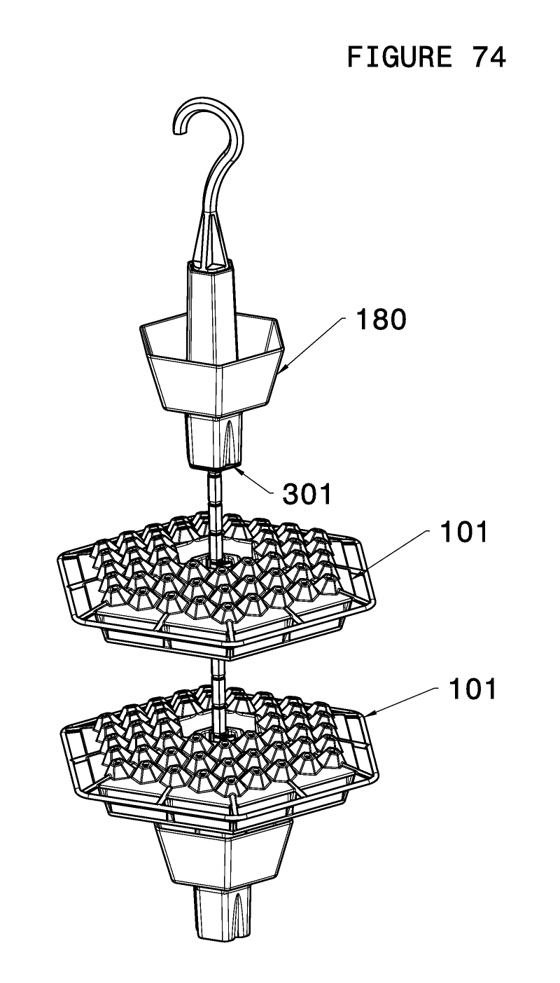

FIG. 74 illustrates the first and second cover member 101, hanger fastening device 301, the support member 180.

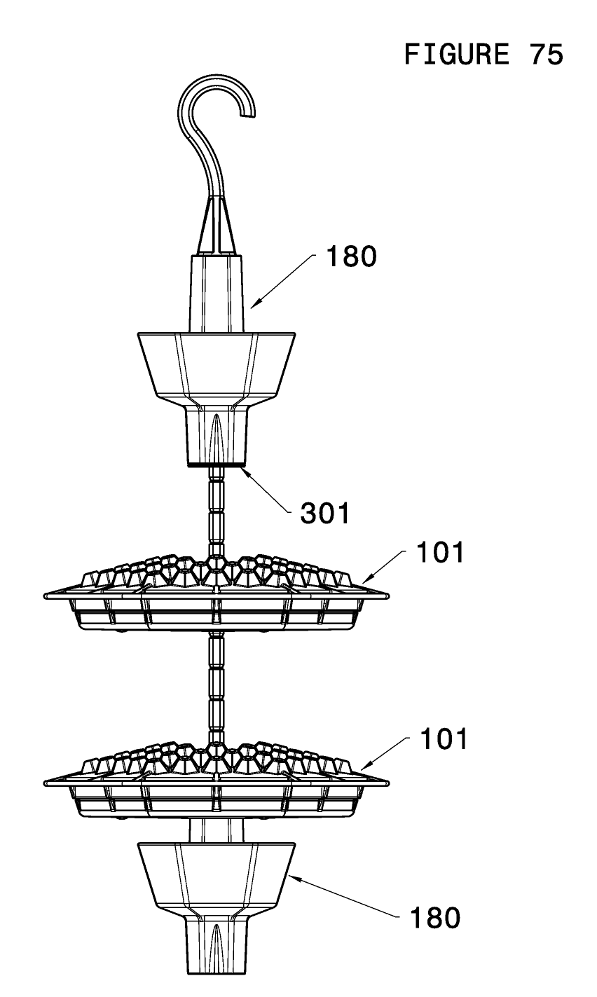

FIG. 75 illustrates the first and second cover member 101, hanger fastening device 301, the first and second support member 180.

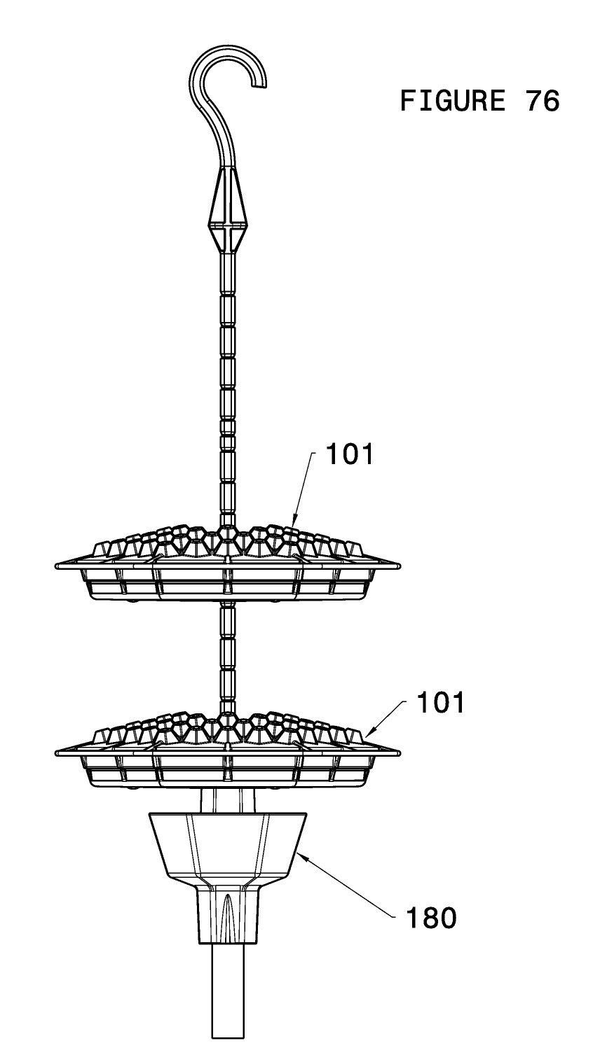

FIG. 76 illustrates the first and second cover member 101, the support member 180 on a pole.

FIG. 77 illustrates cover member 101, base member 151 and support member 180.

FIG. 78 illustrates a section view of cover member 101, base member 151, support member 180 and the bearing member 190.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1. A bird feeder for feeding a bird, comprising:
a base member including a container for nectar;
a cover member to cover the base member including an opening adapted to allow the bird feed the nectar;
a support member to support the base member;
a pole member to connect to the support member.

2) A bird feeder for feeding a bird as in claim 1, wherein the cover member includes an upward extending facet member.

3) A bird feeder for feeding a bird as in claim 2, wherein the upward extending facet member includes inward inclined walls and a central aperture to allow the bird to access the nectar.

4) A bird feeder for feeding a bird as in claim 1, wherein the base member includes a central aperture to cooperate with the support member.

5) A bird feeder for feeding a bird as in claim 1, wherein the cover member includes a perch member to allow the bird to perch on the cover member.

6) A bird feeder for feeding a bird as in claim 1, wherein the base member includes a first ant moat.

7) A bird feeder for feeding a bird as in claim 1, wherein the base member includes a divider member to divide the container of the base member.

8. A bird feeder for feeding a bird as in claim 7, wherein the divider member divides water and sugar.

9) A bird feeder for feeding a bird as in claim 7, wherein the divider member includes a connecting member to connect the divider member to the base member.

10) A bird feeder for feeding a bird as in claim 1, wherein the bird feeder includes a protective member which cooperates with the support member to provide a cover for the bird feeder.

11) A bird feeder for feeding a bird as in claim 10, wherein the protective member includes an ant moat.

12) A bird feeder for feeding a bird as in claim 1, wherein the bird feeder includes multiple feeders on single hanger and includes a flex tab.

13) A bird feeder for feeding a bird as in claim 1, wherein the bird feeder includes a detachable tray.
